(19) United States
(12) Patent Application Publication
(10) Pub. No.: US 2007/0181495 A1
(43) Pub. Date: Aug. 9, 2007

(54) Method of operating a sewage system and such a sewage system

(75) Inventor: Jacobus Eldert Maria Van Baar, Borgon (NL)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Intelligent Environmental Systems B.V., Alkmaar (NL)

(21) Appl. No.: 10/591,103

(22) PCT Filed: Feb. 17, 2005
(86) PCT No.: PCT/NL05/00113

§ 371 Date: Aug. 30, 2006

(30) Foreign Application Priority Data
Mar. 1, 2004 (NL) 1025606

(51) Int. Cl. C02F 3/02; C02F 1/72

(52) U.S. Cl. 210/620

(57) ABSTRACT

The invention relates to a method for operating a sewage system for draining waste water. According to the invention, oxygen is artificially and periodically added to the waste water, for example in that air is periodically blown into a pipe (1) of the sewage system by means of an air pump (4). The invention furthermore relates to a sewage system for carrying out the present method.

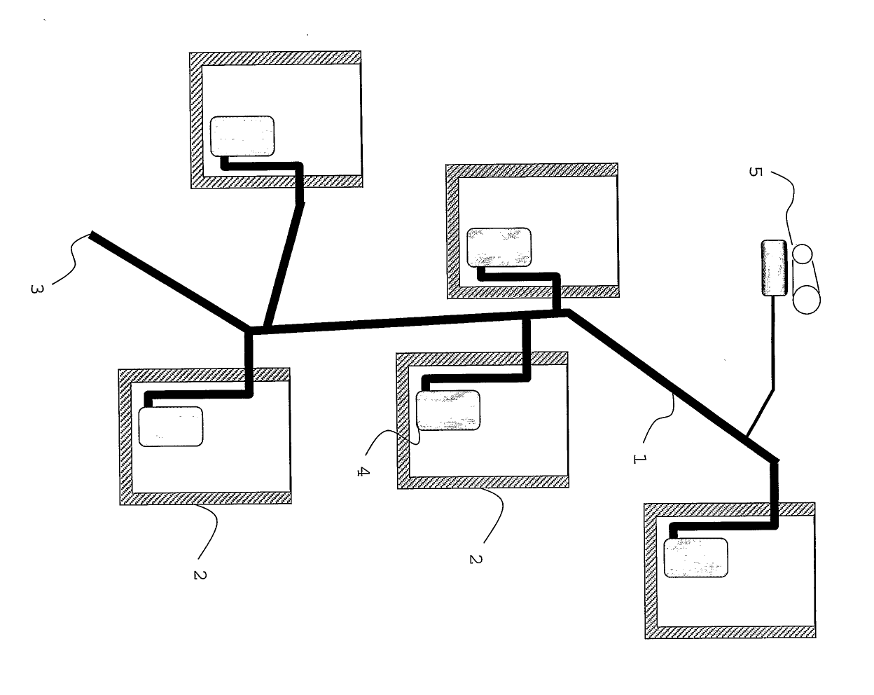

### CROSS-REFERENCE TO RELATED APPLICATION

This Application is a Section 371 National Stage Application of International Application No. PCT/NL2005/000113, filed Feb. 17, 2005 and published as WO 2005/083190 A1 on Sep. 9, 2005, in English.

### BACKGROUND OF INVENTION

The present invention relates to a sewage system and a method of operating a sewage system.

In addition to the use of so-called free-fall sewage systems for long-range transport of waste water, use is generally made of sewage systems in which the waste water is transported to the sewage system under pressure by means of sewage pumps, such as plunger pumps disposed in catch pits.

One feature of these systems is that the waste water only moves in the pressure pipe system when a sewage pump is running. A problem that occurs in this connection is the fact that the waste water to be discharged remains in the sewage system for a prolonged period of time, which may lead to a low oxygen content of the waste water.

These circumstances lead to bacteriological processes by which H₂S is formed in the sewage water in the case of prolonged residence times.

Said bacteriological processes and the formation of H₂S may have the following consequences:
Odor nuisance at the discharge point;
Damage to sewer lines and pumping-stations in the sewage system:
   Accelerated depreciation of the sewage systems;
   Increased usage of materials and, as a result:
      Increased energy consumption for exchanging the damaged materials;
      Increased waste flow;
The purification efficiency of the waste water purification plant may be adversely affected by the low-oxygen water;
Public health hazard, H₂S is highly toxic.

The development of the bacteriological process may take place in the following manner. The temperature of the air in the discharge pit directly above the waste water is higher than the temperature close to the concrete wall (influence of the surrounding ground). As a result, a condensation layer is formed on the concrete wall above the water surface, in which the bacteria may occur that live on the energy that is released in the course of the production of sulphuric acid. Said bacteria use sulphur as an energy source, and produce the sulphuric acid. The fact is that in the presence of oxygen in the atmosphere of the discharge pit and free-fall sewers located downstream thereof, hydrogen sulphide gas is not stable and is converted into sulphur. Free form sulphur is also found in decayed concrete, therefore. Various types of bacteria successively develop in the layer of condensation on the concrete wall, which bacteria produce increasingly higher concentrations of sulphuric acid. The final phase in the formation of sulphuric acid is controlled by the so-called “concrete eater”. This is a type of bacterium that grows optimally in an environment in which the degree of acidity is very high.

As the degree of acidity increases, the cohesion of the cement-bound material is eventually lost. The various corrosion products may remain behind on the concrete surface in the form of a (white) crust of gypsum and hydroxides of aluminium and iron. Said layer can be recognized by its reddish brown colour at very low concentrations already. The “washed-out gravel” effect and the disintegration of the outer layer of concrete form part of the overall image of concrete decay.

### SUMMARY OF INVENTION

An aspect of the present invention is to provide a novel method of operating a sewage system as well as a novel sewage system by which the extent to which H₂S is formed is at least reduced.

To that end, a method of operating a sewage system includes artificially and periodically adding oxygen to the waste water, and a sewage system having a pipe system and pits incorporated therein, and a mechanism at a number of locations in the sewage system configured to artificially and periodically add oxygen to the waste water.

The oxygen content of the waste water can be maintained at the required level by using means whose energy consumption can be low on account of the fact that they are used periodically.

Preferably, air is blown into the sewage system by means of an air pump. This is a relatively simple and inexpensive way of introducing oxygen into the waste water.

It is possible, for example, to add (ambient air containing) oxygen to the sewage system 1 to 20 times per hour, with the oxygen preferably being added at a location as far away from a discharge point of the sewage system as possible.

If the air blowing parameters are selected in dependence on the sewage system parameters, an optimum gearing of the introduction of oxygen can be achieved.

In the sewage system, the air pumps may be disposed in at least a number of the pits, with an air pump being installed in one in 5 to 25 pits, for example.

In most cases this will suffice for introducing sufficient oxygen into the water to prevent the formation of H₂S to a satisfactory extent.

Aspects of the invention will be explained in more detail hereinafter with reference to the drawing, which shows an embodiment of the invention.

### BRIEF DESCRIPTION OF THE FIGURE

The only FIGURE of the drawing is a very schematic representation of a sewage system.

### DETAILED DESCRIPTION OF ILLUSTRATIVE EMBODIMENTS

The drawing very schematically shows a closed sewage system comprising a sewage pipe 1, a number of pits 2 and a discharge point 3. A plunger pump 4 is installed in each of the pits 2, which pump discharges the waste water being collected in the pit as required (a few times a day) by having the pumps run at great intervals so as to forcefully drain the entire sewage pipe.

According to an aspect of the invention oxygen, in particular in the form of air, is artificially introduced into the sewage pipe 1 at regular intervals so as to prevent bacteriological processes from developing. In this way the waste water is prevented from becoming poor in oxygen, which might give rise to the formation of the harmful H₂S. Said oxygen is preferably introduced by means of an air pump or air compressor 5 or the like. For example, a number of 4-20 air compressors may be provided for every 100 sewage pumps, preferably in the pump pits or in separate pits. Said compressors can blow air into the downstream pressure line of the sewage pumps below the surface of the waste water for some time, for example 0.5-1 minute, with a frequency of, for example, once every 5 minutes to once an hour. The compressors may have a capacity of a few m³ per hour. Since the air cannot escape from the closed system, it will be absorbed in the waste water and thus continue to contain sufficient oxygen for preventing anaerobic bacteriological processes from developing. The sewage pipe will be partially drained as a result of air being forced therein. The operation of the compressors (capacity, blowing frequency and blowing amount, etc) will be selected in dependence on the system parameters of the sewage system in question so as to obtain the best possible results.

The invention is not limited to the embodiments as shown in the drawing and described in the foregoing, which can be varied in various ways within the scope of the invention as defined in the claims. Thus it would be possible to use the method of introducing oxygen in free-fall sewage systems.

1. A method of operating a sewage system for draining waste water, comprising artificially and periodically adding oxygen to the waste water.

2. The method according to claim 1, wherein air is periodically blown into the sewage system by means of an air pump.

3. The method according to claim 1, wherein oxygen is added to the sewage system 1-20 times per hour.

4. The method according to claim 1, wherein oxygen is added to the sewage system at a location remote from a discharge point.

5. The method according to claim 1, wherein air blowing parameters are selected in dependence on the sewage system parameters.

6. A sewage system for draining waste water from a number of users to at least one discharge point, comprising a pipe system and pits incorporated therein, and a mechanism for periodically introducing oxygen into the waste water at a number of locations in the sewage system.

7. The sewage system according to claim 6, wherein said mechanism comprises air pumps.

8. The sewage system according to claim 6, wherein said air pumps are installed in at least a number of said pits.

9. The sewage system according to claim 6, wherein an air pump is installed in one in 5 to 25 pits.

10. The sewage system according to claim 7, wherein an air outlet of the air pumps opens below the normal level of the waste water.

11. The sewage system according to claim 7, wherein the pipe system a closed pressurized system, and wherein a sewage pump is installed at least in a number of pits for discharging the waste water from the pit.

12. A method of operating a pressure sewage system for draining waste water, comprising blowing air into the waste water at predetermined intervals by means of an air pump at a location remote from a discharge point and independently of sewage pits.

13. A sewage system for draining waste water from a number of users to a least one discharge point, comprising a closed pressure pipe system and pump pits containing a sewage pump incorporated therein, and further comprising an air pump for introducing air into the waste water at predetermined intervals at a number of locations in the sewage system independent of the pits.
